(19) United States
(12) Patent Application Publication
(10) Pub. No.: US 2019/0207748 A1
(43) Pub. Date: Jul. 4, 2019

(54) BLOCKCHAIN STORAGE DEVICE

(71) Applicant: Seagate Technology LLC, Cupertino, CA (US)

(72) Inventor: Timothy John Courtney, Longmont, CO (US)

(21) Appl. No.: 15/858,214

(22) Filed: Dec. 29, 2017

(51) Int. Cl. H04L 9/06; H04L 9/32; H04L 9/14; H04L 9/30

(52) U.S. Cl. CPC H04L 9/0637; H04L 9/30; H04L 9/14; H04L 9/3247

(57) ABSTRACT

A storage device includes a storage media storing one or more blockchain data structures. The storage device receives objects via payloads and determines whether the objects satisfy a blockchain storage condition. The blockchain storage condition may be based on a type of the object. If the blockchain storage condition is satisfied by the object, then the object is cryptographically signed by a key associated with the storage device and stored in one or more blockchain data structures managed by the storage device. The cryptographically signed object is broadcast to one or more additional storage devices.

### BACKGROUND

A blockchain is a set of transaction blocks that are linked together using hashing methods. A block if a blockchain may include one or more transactions, a hash of a previous block, a time stamp, etc. A blockchain may be public or private, distributed or non-distributed.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following, more particular written Detailed Description of various implementations as further illustrated in the accompanying drawings and defined in the appended claims.

In at least one implementation, a method includes receiving an object at a storage device from a host device. The object is cryptographically signed by the host device. The storage device stores one or more blockchain data structures generated and managed by the storage device. The method further includes determining whether the object satisfies a blockchain storage condition. The blockchain storage condition is based at least on a type of the object. The method further includes cryptographically signing the object using a cryptographic key associated with the storage device and storing the signed object in the one or more blockchain data structures responsive to determining that the object satisfies a blockchain storage condition.

These and various other features and advantages will be apparent from a reading of the following Detailed Description.

### BRIEF DESCRIPTIONS OF THE DRAWINGS

FIG. 1 illustrates an example block diagram of a blockchain storage device.

FIG. 2 illustrates an example data flow diagram for a blockchain storage device system.

FIG. 3 illustrates another example data flow diagram for a blockchain storage device system.

FIG. 4 illustrates another example data flow diagram for a blockchain storage device system.

FIG. 5 illustrates example operations for storing an object to a blockchain stored in a blockchain storage device.

FIG. 6 illustrates alternative example operations for storing an object to a blockchain stored in a blockchain storage device.

FIG. 7 illustrates alternative example operations for storing an object to a blockchain stored in a blockchain storage device.

FIG. 8 illustrates an example processing system that may be useful in implementing the described technology.

### DETAILED DESCRIPTION

Distributed ledgers utilize cryptographic techniques to provide a secure, verifiable record of transactions or data streams. Blockchain is one example of such distributed ledgers. The transactions may indicate storage of data or objects or anything of value. The blockchains may be managed by one or more computing devices and may be public or private, distributed or non-distributed. A blockchain storage device includes a storage media storing one or more blockchain data structures. The storage device determines whether objects received from a host device satisfy a blockchain storage condition and stores the objects to one or more blockchain data structures responsive to determining that the objects satisfy the blockchain storage condition. The storage device includes a cryptography manager storage a private key used to sign objects/transactions stored to a blockchain data structure. Because objects or transactions are signed by a cryptographic key, the blockchain data structures are externally verifiable while being internally managed.

The storage device is configured to generate, based on instructions from a host device, a blockchain data structure and store objects/transactions to the blockchain data structure. Furthermore, the storage device may transmit signed objects/transactions to other devices that are authorized to support the blockchain data structure. Each of the storage devices may be considered “nodes” that support the distributed blockchain data structure. Each of the nodes work together to verify the blockchain and append transactions/objects to the blockchain. A blockchain may be considered an object and may be referenced by a name, for example. Furthermore, different transactions stored to a blockchain data structure may be an object and referenced by a name. The blockchain storage devices described herein may be a self-encrypting drive (SED), a kinetic drive, object storage drives, etc.

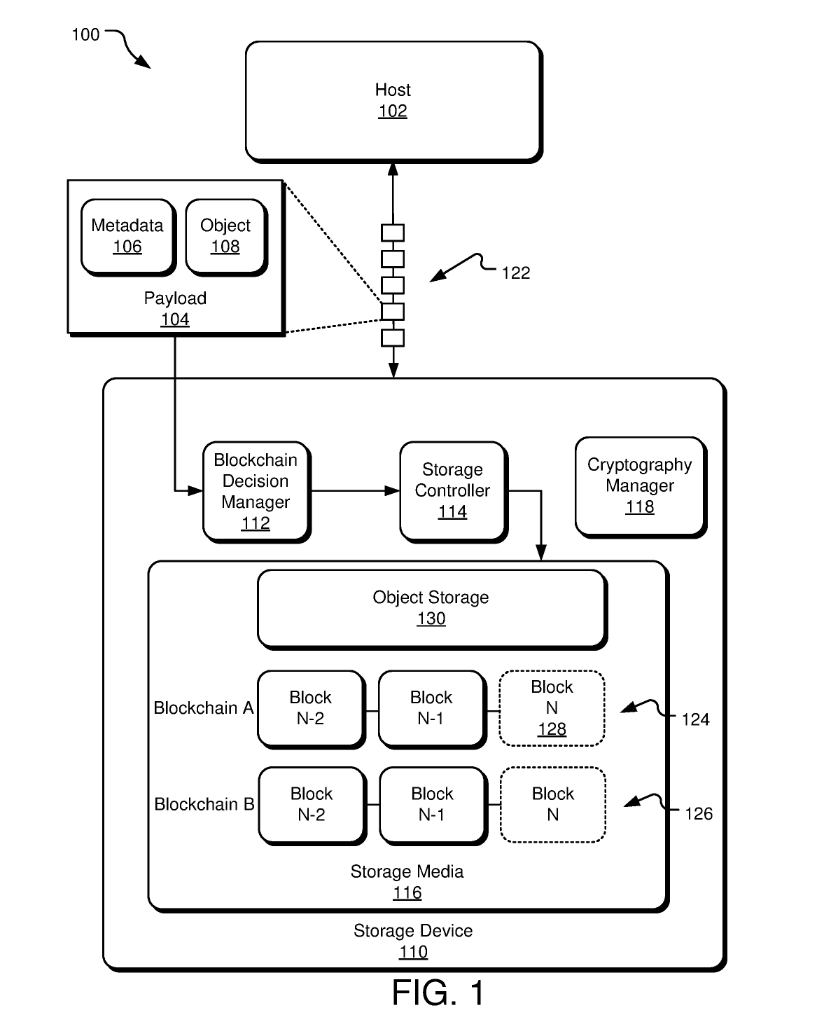

FIG. 1 illustrates an example block diagram 100 of a blockchain storage device 110. The block diagram includes a host device 102. The storage device 110 is illustrated as being separate from the host device 102, but it should be understood that storage device 110 may be implemented in the host device 102. The host device 102 may be a computing device such as a laptop, desktop, server system, etc. The storage device 110 is configured to receive and store objects to a storage media 116. The storage media 116 may comprise various volatile or non-volatile memory storage types including magnetic or optical recording discs, NAND flash memory, rewriteable semiconductor memory (e.g., STRAM, MRAM, RRAM, PCREAM, XRAM, etc.), hybrid memory structures, (e.g., disc and NAND flash), etc.

The host device 102 transmits objects to the storage device 110 for storage in the storage media 116, and the host device 102 may retrieve various objects stored on the storage device 110. The host accesses and saves objects to the storage device 110 using object names, for example. Various objects transmitted to the storage device 110 may be included in payloads (e.g., payloads 122) that are transmitted to the storage device 110. A payload may include the object along with metadata associated with the object. For example, a payload 104 including an object 108 and metadata 106 is transmitted to the storage device 110.

A storage controller 114 of the storage device manages storage of various objects to the storage media 116. Objects may be stored in (e.g., written to) one or more blockchains created and managed by the storage device 110. Different blockchains may be utilized to store different object types. For example, a first blockchain may be utilized to store access logs of the storage device, and second blockchain may be utilized to store documents, document hashes, customer objects including customer data, etc. It is contemplated that other blockchains may be utilized to store various other types of objects including image files, transactions, media files, transactions, etc. The blockchains are utilized to store objects so that the storage of objects is externally verifiable (e.g., based on cryptographic proofs). The blockchain generated and maintained within the storage device 110. The blockchains are used to guarantee the integrity and maintain a complete history of objects (e.g., transactions) written to the storage device 110. It should be understood that the term blockchain includes data structures that may be referred to as ledgers, distributed ledgers, distributed ledger technology, directed acyclic graphs where nodes are cryptographically linked, etc. These data structures include a set (e.g., one or more) of transaction blocks that are linked together with hashing methods.

To utilize the storage device 110, a user (e.g., using the host device 102) may open a blockchain session to the storage device. In this session, the user can create a new blockchain, add a new transaction to an existing blockchain, verify a blockchain, read a blockchain, lock a blockchain etc. Such functions may be controlled by access rights. In FIG. 1, a user has utilized the host device 102 to open a blockchain session and has transmitted a payload 104 to the storage device 110. The payload 104 includes the object 108 and metadata 106 associated with the object 108. The object 108 may be cryptographically signed by a signing key (e.g., a signing key) of the host device 102 or the user of the host device 102. The object 108 may include data such as a document, an image (e.g., image data), access logs, financial transactions, a customer object including customer data, etc. The metadata 106 may include flag or field that indicates a level of importance of the object, an indication of a blockchain managed by the storage device 110, a level of access by a user of the host device 102 (e.g., a pin number indicating a level of access), a level of redundancy, etc. After the user opens a blockchain session and performs some blockchain operations (e.g., create new blockchain, write to blockchain, read from blockchain), the user closes the session.

When the object 108 is received by the storage device 110, the object is stored in an object storage 130 of the storage media 116. Furthermore, a blockchain decision manager 112 of the storage device 110 analyzes the object 108 and/or the metadata 106 to determine whether the object satisfies a blockchain storage condition. Such analysis may include determining the type of object (e.g., document or image), determining a level of importance, determining access rights, validating a signature, etc. Based on the determination, the blockchain decision manager 112 may determine that the object 108 should be stored in one or more blockchain data structures stored in the storage media 116. The object and the determination is transmitted to the storage controller 114 which stores the object to the requisite blockchain. For example, depending on the determination, the storage controller 114 may store the object 108 to a blockchain A 124 or a blockchain B 126, or both, for example. The blockchain storage condition may also be determined based on the object type. For example, if the object is a document, a first blockchain storage condition may be selected, and if the object is one or more access logs, then a second blockchain storage condition may be selected. The blockchain storage condition may further depend on the metadata included in the payload. Such metadata may indicate a level of importance of the object, a level of redundancy, a pin, etc.

Before an object is stored to a blockchain, a cryptography manager 118 of the storage device may sign the object to generate an object transaction. The cryptography manager 118 may be implemented as a cryptographic/trusted chip or secure platform firmware. The cryptography manager 118 may include a root of trust used to generate and manage cryptographic keys such as cryptographic key pairs (e.g., public and private keys). These keys may be generated using RSA methods, elliptic-curve cryptography methods, or another key generation method. A generated private key may be securely stored in the cryptography manager 118. The public key associated with a private key may be transmitted to the host device 102 and other network devices using certificates, for example. Accordingly, the cryptography manager 118 may utilize or include a certificate authority based on the root of trust for key generation and distribution. Before an object is stored to a blockchain, the object (or a representation of the object, such as a hash output) may be signed by the private key. One or more objects/transactions may be stored in a block (e.g., a block N 128 of the blockchain A 124) in a blockchain. A block may include a nonce, a hash of a previous block, a timestamp, one or more objects, etc. The hash of the previous block is used to link blocks of objects/transactions together in a “chained” data structure. The timestamp indicates the data and time of the block creation. Once the object is stored to a blockchain data structure of the storage device 110, the storage of the object may be verified using the public key used associated to the private key. Furthermore, because an object may be originally signed by a key associated with the host device 102 or the user of the host device 102 and the storage device 110 that generates the blockchain transaction, a complete forensic history of objects may be produced.

The blockchain data structures 124 and 126 managed by the storage device 110 may be distributed or non-distributed. A distributed blockchain data structure is stored/copied across various other storage devices 110. Accordingly, the storage device 110 may be networked to other storage devices that store copies of the blockchain. As such, when the storage device 110 signs a transaction/object and stores it to a blockchain stored in the storage media 116, the storage device 110 may transmit the signed object to other storage devices. The other storage devices verify the object/transaction using the public key and store the object/transaction to their copy of the blockchain after verification. Similarly, the storage device 110 may receive signed transactions/objects from other storage devices. The storage device 110 verifies the received transactions using a public key associated with a private key securely stored on the other storage device. If the object/transaction is verified, the storage device 110 stores the signed object to the requisite blockchain stored in the storage media 116. An object stored to a blockchain of the storage device 110 may not be completely verified until a requisite number of verifications are performed by other networked storage devices. The verification techniques and threshold may be dependent on the blockchain. For example, the blockchain A 124 may require a first threshold number of verifications, and the blockchain B 126 may require a second threshold number of verifications. Furthermore, the structure of the blockchains may vary between different blockchains. Accordingly, the blockchain decision manager 112 and the storage controller 114 are configured to manage the different blockchain types. In effect, each of the blockchain types are managed by blockchain nodes, which may comprise a combination of the blockchain decision manager 112, the storage controller 114, and blockchain parameters, which are enforced by the blockchain decision manager 112 and the storage controller 114.

To create a blockchain, a user using the host device 102 may transmit an blockchain instruction to the storage device 110. The instruction may include parameters indicating a type of blockchain (e.g., types of objects and or blockchain structure), access rights, and indication of whether the blockchain will be distributed, etc. To control access rights, the user may have a pin and indicate that the only users that have access to that pin can edit the created blockchain. Furthermore, the user can indicate a set of pins that have access rights. Varying levels of access may be indicated that permit reading from and/or writing to the blockchain, locking the blockchain, etc. If the created blockchain is to be distributed, the instructions may include an identification of other parties/devices that will support the blockchain. In response to the instruction, the storage device 110 may generate the blockchain and store it on the storage media 116. The blockchain decision manager 112 stores the parameters for use in subsequent read/write requests for the generated blockchain. If the blockchain is distributed, an identification (and parameters) of the blockchain are transmitted to the other devices supporting the blockchain. In some implementations, login credentials (e.g., username/password) may be utilized by a user to manage the storage device 110 and/or various blockchain data structures 124 and 126. In exemplary implementations, drives/devices may be added to store a copy of the blockchain. Access rights may be utilized to add a device to a blockchain system.

After the blockchain is generated, the host device 102 may transmit an object to the storage device 110 for storage in one or more blockchains. The object may be transmitted in a payload which may include metadata. The metadata may include one or more pins. The blockchain decision manager 112 analyzes the received payload and determines whether the received pins have write access to the generated blockchain (e.g., using the stored parameters). If the pin has access rights, the blockchain decision manager 112 selects the blockchain and transmits the information to the storage controller 114. The storage controller 114 stores the object to the generated blockchain using the methods described herein.

The host device 102 may also transmit a read request that identifies a blockchain or an object in the blockchain. The request may be included in a payload which includes metadata such as a pin associated with a user. The blockchain decision manager 112 determines whether the request has access rights based on the pin. If the blockchain decision manager 112 determines that the request has access rights, then the blockchain decision manager 112 instructs the storage controller 114 to retrieve the identified object or blockchain. The requested information is then transmitted to the host device 102.

In some example implementations, a read request from a non-contributor (e.g., a host/user that does not have write access) is recorded as a transaction to a blockchain data structure. For example, if the host device 102 transmits a read request, the blockchain decision manager 112 determines that the read request has read access (e.g., based on pin or cryptographically signed request) and records a transaction to one or more blockchain data structures. The transaction includes the user/host device that requested access. Accordingly, a complete forensic history is recorded for blockchain transactions. A blockchain data structure may be dedicated to recording read/write request transactions or such transactions may be recorded to the blockchain data structure being accessed. Similarly, if a read/write request is rejected (e.g., based on invalid signing, invalid pin, invalid object), then a repudiation transaction may be generated and stored in one or more blockchain data structures. The repudiation transaction may include an indication of the party (e.g., host device) that requested access to the blockchain data structure. The indication may include a public key associated with the party requesting access.

The cryptography manager 118 may store an index of pins associated with cryptographic keys or key pairs. Accordingly, when a user transmits an object to the storage device 110 with an identification of a pin, the cryptography manager 118 may retrieve the key associated with the pin to sign the object before storage of the object to the storage device. Accordingly, the object is verifiable as being transmitted by a pin and signed by a key generated by the storage device 110.

Blockchains may be used to store different objects/transactions including, for example, images, documents, document changes, access logs, transactions involving different type of objects, etc. Each blockchain may be identified by using a blockchain ID, which may be used to open a blockchain session, edit a blockchain data structure, and close a blockchain session. In one example, a blockchain is utilized to store document records. The document blockchain can be used to determine integrity of a document during the document history. For example, a first draft of a document is stored to the storage device 110, and a document blockchain is utilized to store the history of the document. The cryptography manager 118 performs a cryptographic hash (e.g., SHA-1, SHA-2, SHA-3) of the documents and stores the hash output in the document blockchain as a transaction. The document itself may be stored to another location in the storage media 116. When a subsequent version of a document is stored to the storage device 110, the blockchain decision manager 112 determines the amount of change to the document relative to the previously stored document. The blockchain decision manager 112 may retrieve the previously stored copy of the document of the storage media 116 and compare it to the new version of the documents. If the new document has changed (e.g., delta) above a threshold, then a new cryptographic hash is performed by the cryptography manager 118, and the new hash output is stored to the document blockchain. The new hash may be linked to the previous hash using various techniques. One blockchain may be utilized to store the history of a single document, or one blockchain may be utilized to store hash functions of several documents. The blockchain of hash outputs of documents may be utilized to verify integrity of a document at a certain time. It should be understood that the term “document” is not limited to text documents and may include contracts, programs, code, or other types of media.

Another example blockchain is a blockchain that is configured to store access logs to the storage device. For example, each time an object is transmitted to the device for storage to the storage media 116, such activity is monitored and tracked by the storage device 110. Accordingly, a verifiable history of access (e.g., read/write access) may be logged to access log blockchain. A single access log blockchain may be utilized to document access logs to the storage device itself or to document access to one or more blockchains managed by the storage device 110 (or networked device). Similarly, access logs stored to a blockchain may be based on a level or change in a level of access to the storage device. For example, an administrator of the storage device 110 may edit the level of access to the storage device 110. Such changes be logged and stored to the access log blockchain.

In some example implementations, an object/transaction is cryptographically signed by the host device 102 before it is transmitted to the storage device 110. Accordingly, the blockchain decision manager 112 may determine whether the object is validly signed using a public key associated with the host device 102. The cryptography manager 118 may store an index of public keys that have read and/or write access to one or more of the blockchain data structures 124 and 126. Accordingly, the blockchain decision manager determines, using the index, whether the object is validly signed by a private key. Furthermore, the blockchain decision manager 112 may select one of the blockchain data structures 124 and 126 based on the cryptographic signature in addition to any metadata included in the payload. If the object is a read request, the decision manager 112 may determine whether the signature is associated with read access. If so, then an access transaction may be generated and stored to one or more blockchain data structures. If the read request does not have access rights, then a repudiation transaction may be recorded to one or more blockchain data structures. Accordingly, the complete forensic history of blockchain access is stored.

The host device 102 may include a cryptography manager that manages cryptographic keys. The host device 102 may include a set of keys that are used based on different objects and/or blockchains. For example, a first key pair may be utilized for a document blockchain data structure, and a second key pair may be utilized for an image blockchain data structure. Similarly, different keys may be associated with different users of the host device 102. When a blockchain data structure is created by the host device, the host device 102 may indicate which keys have what level of access (e.g., read and/or write access, administrative access). Accordingly, the cryptography manager 118 stores a record/index of levels of access for the generated blockchain. Subsequently, access records associated with a blockchain data structure may be changed using a key with administrative access. A change in access records may include, for example, a change in a level of access associated with a key, an addition of a key to the access records, or a removal of a key from the access records.

A change in access rights, blockchain type, blockchain parameters, etc. may be instituted using a rule change transaction. For example, the user of the host device 102 may select a blockchain and a change in blockchain storage conditions and generate a rule change transaction that is signed by a signing key associated with the user or the host device 102. The signed rule change transaction is transmitted to the storage device 110, and the blockchain decision manger 112 determines whether the rule change transaction the user has the requisite rights to change the rules. The determination may be based on validation of the cryptographic signature, for example.

In some example implementations, users or parties are incentivized to run a blockchain node (e.g., the storage device 110) for access to verified data objects. Accordingly, the more parties running blockchain nodes means that the data is more secure and completely verified. Furthermore, some parties, such as customers, may pay to access the secure and verified data. Such example customers may be “read-only” users because they can only read data but not add data (e.g., append) to the blockchains. Other incentive structures are contemplated.

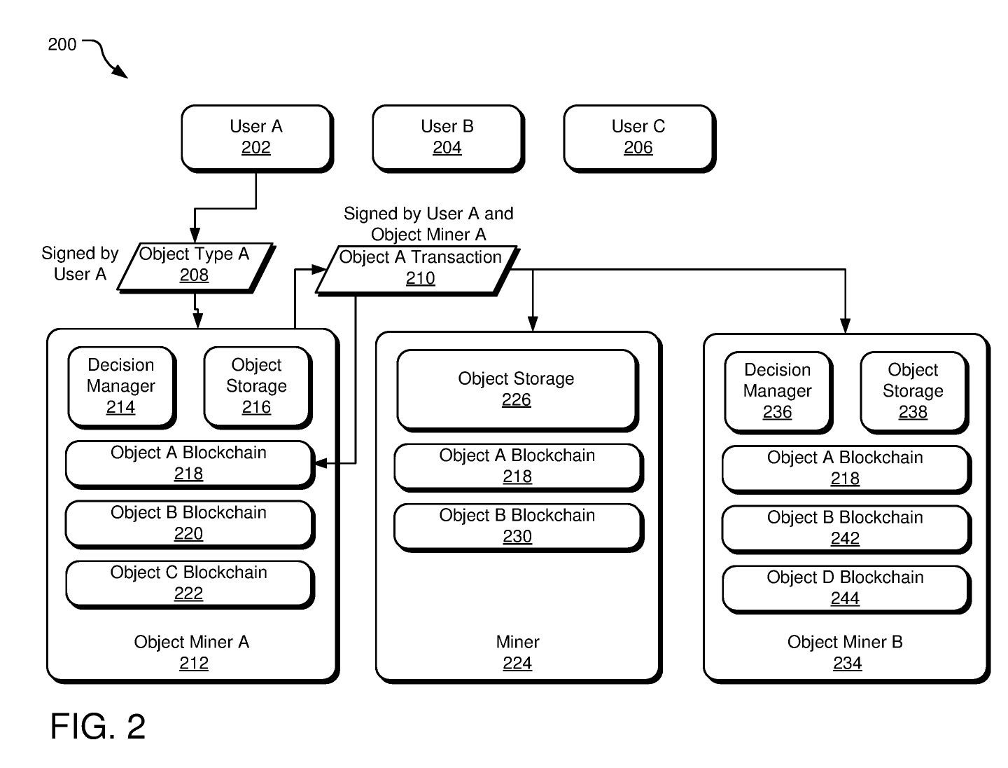

FIG. 2 illustrates an example data flow diagram 200 for a blockchain storage device system. The data flow diagram 200 includes user A 202, user B 204, and user C 206. Such users may utilize one or more different host computing devices to store objects to one or more storage devices that may/may not store objects to different blockchains based one or more blockchain storage conditions. Each of the user A 202, the user B 204, and or the user C 206 may be associated with a key pair (e.g., RSA or elliptic curve) that includes a public and a private key. The private keys may be used to cryptographically sign objects sent to the one or more blockchain storage devices. These cryptographic signatures may be utilized to verify the origin of the signed objects.

Example blockchain storage devices include an object miner A 212 or an object miner B 234, which may be implemented as a storage device configured to store objects generated by a host computing device corresponding to the user A 202, the user B 204, and/or the user C 206. The object miner A 212 and the object miner B 234 include blockchain decision managers 214 and 236, respectively. The blockchain decision managers 214 and 236 are configured to analyze received objects to determine whether the objects satisfy the one or more blockchain storage conditions. If the objects do satisfy a blockchain storage condition, then the objects may be stored to one or more blockchains stored on the object miners. If the objects do not satisfy a blockchain storage condition, then the objects may be stored in an object storage. The object miner A 212 includes object storage 216, and the object miner B 234 includes the object storage 238. The object miners 212 and 234 and the miner 224 may be geographically co-located in the same room of a building or may be geographically separated in different rooms, buildings, countries, continents, etc. The object miners 212 and 234 may be communicatively connected over a communication network that includes a number of components facilitating network communication. The object miners 212 and 234 may include cryptography managers (not shown) that manage one or more cryptographic key pairs associated with the object miners, respectively. The cryptography managers may be further utilized to perform other cryptographic functions such as hashing (e.g., linking transaction blocks for blockchains) and encryption.

A miner 224 is another example of a blockchain storage device. The miner 224 does not include a blockchain decision manager. Rather, the miner 224 receives transactions from other devices/users where the other devices/users have already validated the transaction. The miner 224 receives transactions and stores them to respective blockchains. It should be understood that a blockchain storage device system may include more devices than illustrated in FIG. 2. Furthermore, as illustrated, different devices may include different blockchains. For example, an object C blockchain 222 is a non-distributed blockchain and is managed by the object miner A 212. Similarly, an object D blockchain 244 is a non-distributed blockchain which is managed by the object miner B 234. Only user C 206 may have access to the object D blockchain 244, for example. Furthermore, different blockchains on a device may be public or private.

In FIG. 2, the user A 202 signs an object (e.g., an object type A 208) using the private key associated with the user A 202. The signed object type A 208 is transmitted to the object miner A 212. The signed object type A 208 may be transmitted to the object miner A 212 because the object miner A 212 is the local storage device to the user A 202. The signed object type A 208 may be transmitted as a part of a payload. The signed object type A 208 is stored in the object storage 216, and he decision manager 214 analyzes the signed object type A 208 to determine whether the signed object type A 208 satisfies a blockchain storage condition. Based at least on the object type (e.g., type A) and validation of the signature, the object type A 208 satisfies one or more blockchain storage conditions. The object miner A 212 cryptographically signs the object type A 208 using the private key (e.g., signing key) to yield an object A transaction 210. In implementations, the object A transaction 210 is a doubly signed object (e.g., signed by the user A 202 and the object miner A 212).

The object A transaction 210 is stored in an object A blockchain 218, which is distributed blockchain. Accordingly, the object A blockchain 218 is synced across the object miner A 212, the miner 224, and the object miner B 234. To synchronize the blockchains, the object miner A 212 broadcasts the object A transaction 210 to the miner 224 and the object miner B 234. The miner 224 and the object miner B 234 check for valid signatures by the transaction originator (e.g., the user A 202) and the original miner (e.g., the object miner A 212) and stores the object A transaction 210 to the respective blockchains responsive to the validation of the signatures. Accordingly, an object miner may be considered the authenticator of a valid blockchain transactions, and a miner may be considered a device that receives an authorized transaction. In some example implementations, the signed object type A 208 is also transmitted to the miner 223 and the object miner B 234 for storage in the object storage 226 and the object storage 238, respectively. Accordingly, the object type A 208 may be retrieved from any of the devices and validated by any of the devices using the object A blockchain 218.

Because the object A 210 is signed by both the user A 202 and the object miner A 212, the lineage of the object A 208 may be traced and verified (e.g., integrity and no-repudiation). Accordingly, when the object A 208 is later retrieved from one or more of the devices, the integrity of the object A 208 may be confirmed utilizing the object A blockchain 218.

In one example implementation, the object type A 208 does not satisfy a blockchain storage condition. As such, the signed object type A 208 may be stored in the object storage 216. The object type A 208 may not satisfy the blockchain storage condition based on an invalid signature and/or invalid access rights to a blockchain. In another example, the object type A 208 does not satisfy the blockchain storage condition because the object miner A 212 does not include a blockchain for storing objects of type A. In some example implementations, an object is not signed before being transmitted to an object miner (e.g., a storage device). In such an example, the object may not be authorized to be stored in a blockchain. In other words, an unsigned object does not satisfy a blockchain storage condition in some example implementations. The unsigned object may be stored in the object storage 216, for example.

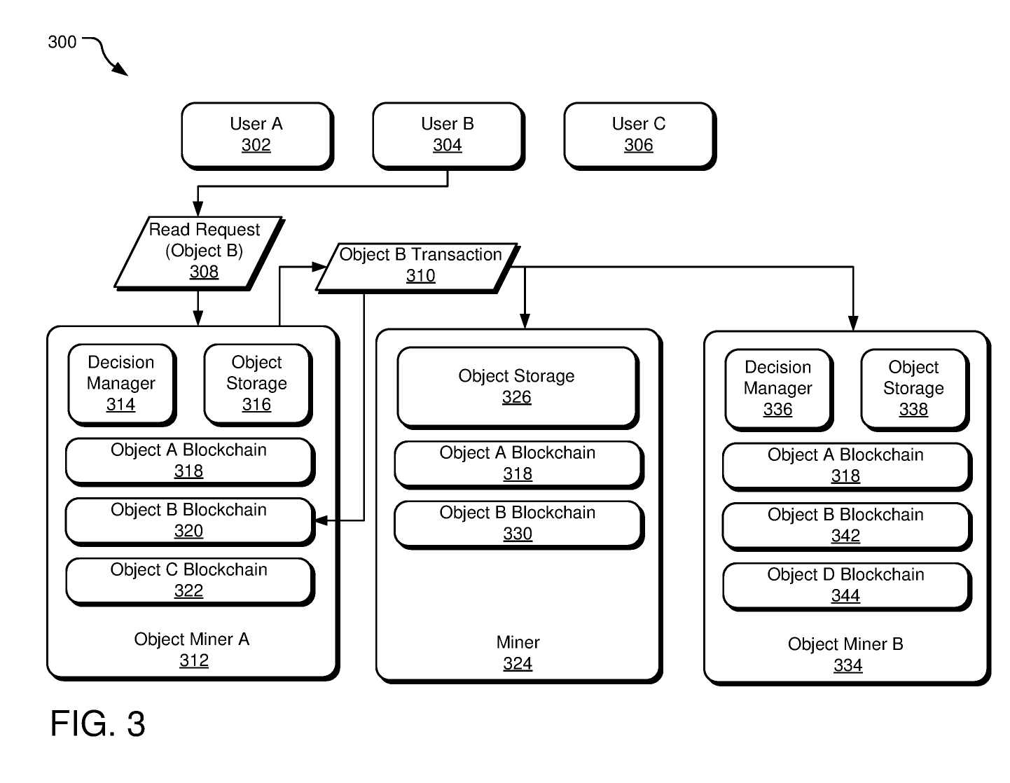

FIG. 3 illustrates another example data flow diagram 300 for a blockchain storage device system. The data flow diagram 300 includes user A 302, user B 304, and user C 306. Such users may utilize one or more different host computing devices to store objects to one or more storage devices that may/may not store objects to different blockchains based one or more blockchain storage conditions. Each of the user A 302, the user B 304, and or the user C 306 may be associated with a key pair (e.g., RSA or elliptic curve) that includes a public and a private key. The private keys may be used to cryptographically sign objects sent to the one or more blockchain storage devices. These cryptographic signatures may be utilized to verify the origin of the signed objects.

Example blockchain storage devices include an object miner A 312 or an object miner B 334, which may be implemented as a storage device configured to store objects generated by a host computing device corresponding to the user A 302, the user B 304, and/or the user C 306. The object miner A 312 and the object miner B 334 include blockchain decision managers 314 and 336, respectively. The blockchain decision managers 314 and 336 are configured to analyze received objects to determine whether the objects satisfy the one or more blockchain storage conditions. If the objects do satisfy a blockchain storage condition, then the objects may be stored to one or more blockchains stored on the object miners. If the objects do not satisfy a blockchain storage condition, then the objects may be stored in an object storage. The object miner A 312 includes object storage 316, and the object miner B 334 includes the object storage 338. The object miners 312 and 334 and the miner 324 may be geographically co-located in the same room of a building or may be geographically separated in different rooms, buildings, countries, continents, etc. The object miners 312 and 334 may be communicatively connected over a communication network that includes a number of components facilitating network communication. The object miners 312 and 334 and the miner 324 may include cryptography managers (not shown) that manage one or more cryptographic key pairs associated with the object miners, respectively. The cryptography managers may be further utilized to perform other cryptographic functions such as hashing (e.g., linking transaction blocks for blockchains) and encryption.

The miner 324 is another example of a blockchain storage device. The miner 324 does not include a blockchain decision manager. Rather, the miner 324 receives transactions from other devices/users where the other devices/users have already validated the transaction. The miner 324 receives transactions and stores them to respective blockchains. It should be understood that a blockchain storage device system may include more devices than illustrated in FIG. 3. Furthermore, as illustrated, different devices may include different blockchains. For example, an object C blockchain 322 is a non-distributed blockchain and is managed by the object miner A 312. Similarly, an object D blockchain 344 is a non-distributed blockchain which is managed by the object miner B 334. Only user C 306 may have access to the object D blockchain 344, for example. Furthermore, different blockchains on a device may be public or private.

In FIG. 3, the user B 304 broadcasts a read request 308 to the object miner A. The read request 308 may be signed by a signing key of the user B 304, and the read request 308 is a request for an object of type B. The decision manager 314 determines that the read request 308 is valid. Such a determination may depend on the cryptographic signature or may be based on access rights managed by the object miner A 312. After validating the read request 308, the requested object is retrieved from the object storage 316 and returned to the user B 304. Furthermore, an object B transaction 310 is generated based on the read request. The object B transaction 310 indicates that a valid read request was received by the object miner A 312 from the user A 302. The object B transaction 310 is stored to an object B blockchain 320 stored on the object miner A 312 and is broadcast to other devices supporting the object B blockchain 220. Such devices include the miner 223 and the object miner 234. Accordingly, a record of the read request is securely stored in the devices. In some example implementations, the object B transaction is signed by the object miner A 312.

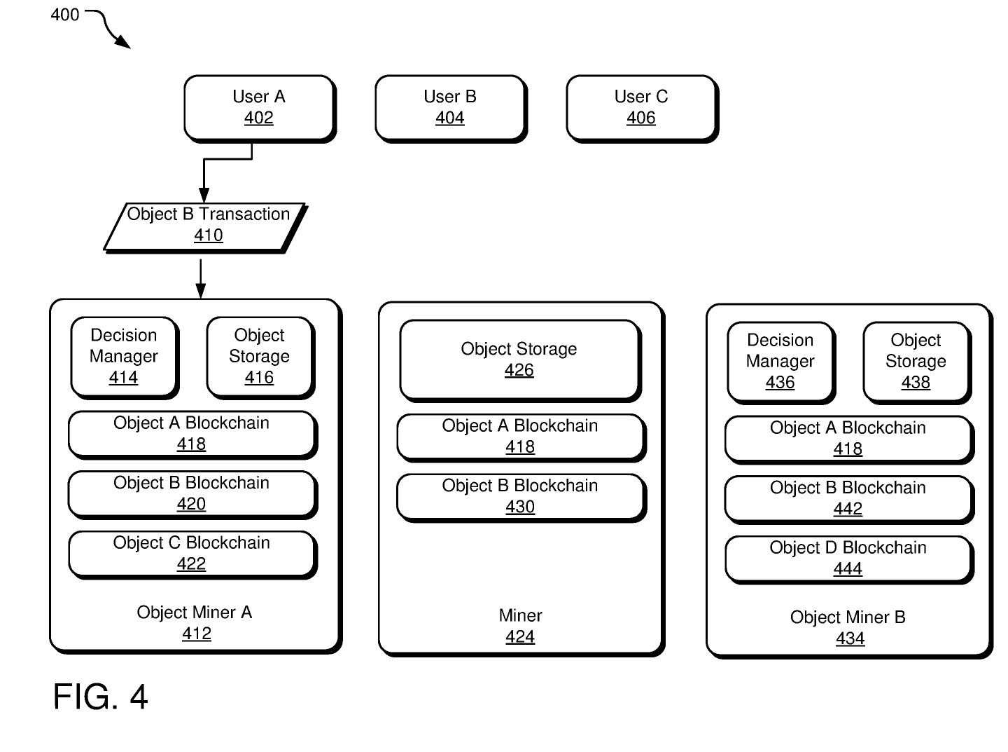

FIG. 4 illustrates another example data flow diagram 400 for a blockchain storage device system. The data flow diagram 400 includes user A 402, user B 404, and user C 406. Such users may utilize one or more different host computing devices to store objects to one or more storage devices that may/may not store objects to different blockchains based one or more blockchain storage conditions. Each of the user A 402, the user B 404, and or the user C 406 may be associated with a key pair (e.g., RSA or elliptic curve) that includes a public and a private key. The private keys may be used to cryptographically sign objects sent to the one or more blockchain storage devices. These cryptographic signatures may be utilized to verify the origin of the signed objects.

Example blockchain storage devices include an object miner A 412 or an object miner B 434, which may be implemented as a storage device configured to store objects generated by a host computing device corresponding to the user A 402, the user B 404, and/or the user C 406. The object miner A 412 and the object miner B 434 include blockchain decision managers 414 and 436, respectively. The blockchain decision managers 414 and 436 are configured to analyze received objects to determine whether the objects satisfy the one or more blockchain storage conditions. If the objects do satisfy a blockchain storage condition, then the objects may be stored to one or more blockchains stored on the object miners. If the objects do not satisfy a blockchain storage condition, then the objects may be stored in an object storage. The object miner A 412 includes object storage 416, and the object miner B 434 includes the object storage 438. The object miners 412 and 434 and the miner 224 may be geographically co-located in the same room of a building or may be geographically separated in different rooms, buildings, countries, continents, etc. The object miners 412 and 434 may be communicatively connected over a communication network that includes a number of components facilitating network communication. The object miners 412 and 434 may include cryptography managers (not shown) that manage one or more cryptographic key pairs associated with the object miners, respectively. The cryptography managers may be further utilized to perform other cryptographic functions such as hashing (e.g., linking transaction blocks for blockchains) and encryption.

A miner 424 is another example of a blockchain storage device. The miner 424 does not include a blockchain decision manager. Rather, the miner 424 receives transactions from other devices/users where the other devices/users have already validated the transaction. The miner 424 receives transactions and stores them to respective blockchains. It should be understood that a blockchain storage device system may include more devices than illustrated in FIG. 4. Furthermore, as illustrated, different devices may include different blockchains. For example, an object C blockchain 422 is a non-distributed blockchain and is managed by the object miner A 412. Similarly, an object D blockchain 444 is a non-distributed blockchain which is managed by the object miner B 434. Only user C 406 may have access to the object D blockchain 444, for example. Furthermore, different blockchains on a device may be public or private.

In FIG. 4, the user A 402 generates, signs, and transmits an object B transaction 410. The object B transaction 410 may be referred to as a user generated blockchain transaction because it is generated by the user A 402 rather than one of the object miners. The object B transaction 410 forces the devices supporting object be to store an object to the object B blockchain. Accordingly, each of the devices respond as simple miners (rather than object miners) and as if the transaction was generated by an object miner. The object miner A 412 receives the object B transaction 410 and stores the signed object B transaction to the object B blockchain 420. The decision manager 414 does not make any decision with regard to any blockchain storage condition. The decision manager 414 may determine that the user A 402 is authorized to create such a transaction based on the signature. The object B transaction 410 is transmitted to the other devices. It should be understood that the user A 402 may transmit the object B transaction 410 to the devices or that the object miner A 412 relays the object B transaction 410 to the other devices.

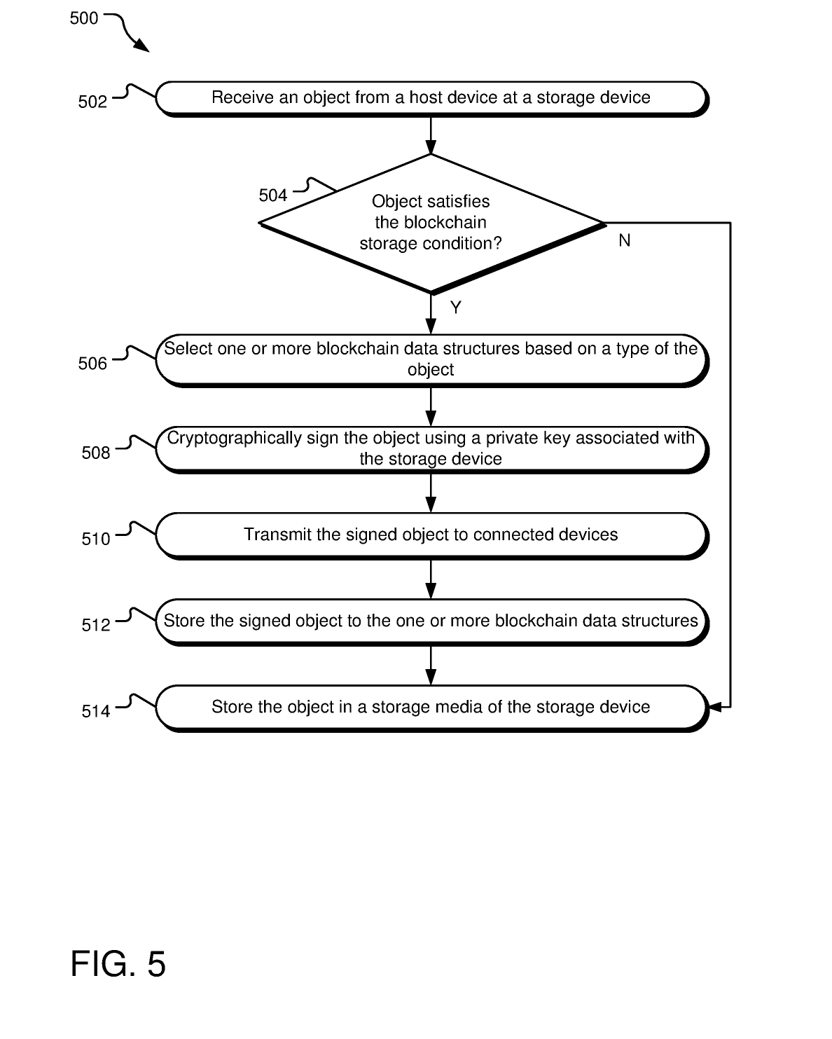

FIG. 5 illustrates example operations 500 for storing an object to a blockchain stored in a blockchain storage device. A receiving operation 502 receives an object from a host device at a storage device. The object may be signed by a signing key of the user of the host device and may be included in a payload. An determining operation 504 determines whether the object satisfies a blockchain storage condition. The determining operation 504 may read metadata included in the payload, confirm a valid singing of the object, etc. The metadata may include a pin, a level of access, object type, etc. The determining operation 504 may further determine the object type by analyzing the object. The blockchain storage condition may be based on an indication of importance, an indication of redundancy, the type of object, etc. For example, if the payload includes metadata with a field indicating a high level of redundancy, then the object satisfies the blockchain storage condition. If the object satisfies the blockchain storage condition, a selecting operation 506 selects one or more blockchain data structures based at least on the type of the object. For example, if it is determined that the type of the object is an access log, the selecting operation 506 selects the access log data structure. The selection may be further based on a level of access (e.g., based on a pin) or level of redundancy indication. For example, if the high level of redundancy is indicated, then a distributed blockchain (of the object type) may be selected. Similarly, if a medium level of redundancy is indicated, then a non-distributed blockchain data structure may be selected. If a low level of redundancy is indicated, then the storage condition may not be satisfied.

A signing operation 508 cryptographically signs the object using a private key associated with the storage device (e.g., associated with a public key of the storage device). A transmitting operation 510 transmits the signed object to connected/networked devices. The transmitting operation 510 may occur when the blockchain is distributed. A storing operation 512 stores at least a representation of the object to the selected one or more blockchain data structures. The storing operation 512 may coincide with the transaction being “mined” (e.g., verified) by other connected/networked storage devices. A storing operation 514 stores the object tin the storage media of the storage device. If the object does not satisfy the blockchain storage condition, then a storing operation 514 stores the object in a storage media of the storage device without storing the object in a blockchain data structure.

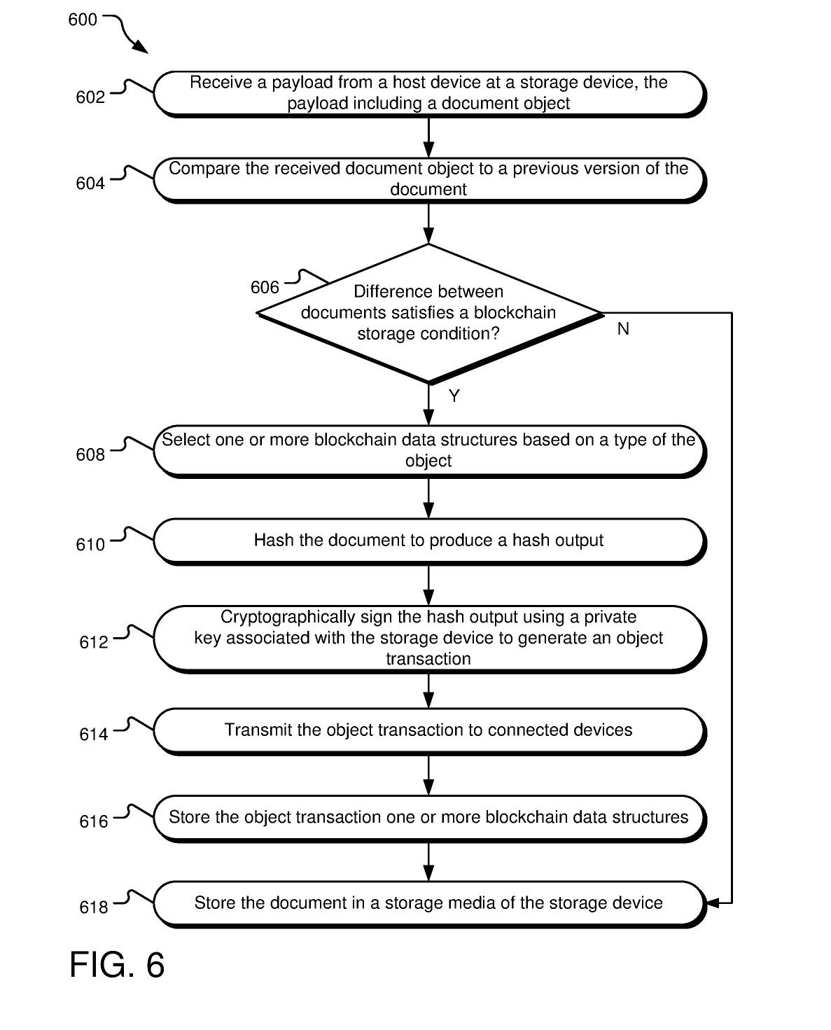

FIG. 6 illustrates alternative example operations 600 for storing an object to a blockchain stored in a blockchain storage device. Specifically, FIG. 6 illustrates the operations 600 when the object is a document. A receiving operation 602 receives a payload from a host device at a storage device. The received payload includes a document object, which may be signed by a signing key of the user of the host device. A comparing operation 604 compares the received document to a previous version of the document. A determining operation 606 determines whether the difference between the documents satisfies a blockchain storage condition. For example, the blockchain condition may correspond to a threshold percentage of the document being changed. If, for example, 15% of the document has been changed, then the blockchain storage condition is satisfied. If the blockchain storage condition is satisfied, then a selection operation 608 selects one or more blockchain data structures based on the type of the object (e.g., document). Accordingly, a blockchain data structure for storing documents or representations of documents may be selected.

A hashing operation 610 hashes the document to produce a hash output. A signing operation 612 cryptographically signs the hash output using a private key associated with the storage device to generate an object transaction. A transmitting operation 614 transmits the object transaction to connected devices. A storing operation 616 stores the object transaction to one or more blockchain data structures. Another storing operation 618 stores the documents as a document object in the storage media of the storage device. If it is determined that the differences between the documents do not satisfy the blockchain storage condition, then the storing operation 618 stores the document in the storage media of the storage device. Accordingly, if another version of the documents is transmitted to the storage device, then the previously stored version may be used for comparison.

In some implementations, each document transmitted to the storage device is hashed and stored to a document blockchain such that hash outputs may be used to establish document histories. In such implementations, the blockchain storage condition may be based on an indication of importance included with the payload including the document. If the document is deemed important, then the blockchain storage condition is satisfied and the document is hashed to produce the hash output, which is stored to one or more blockchain data structures.

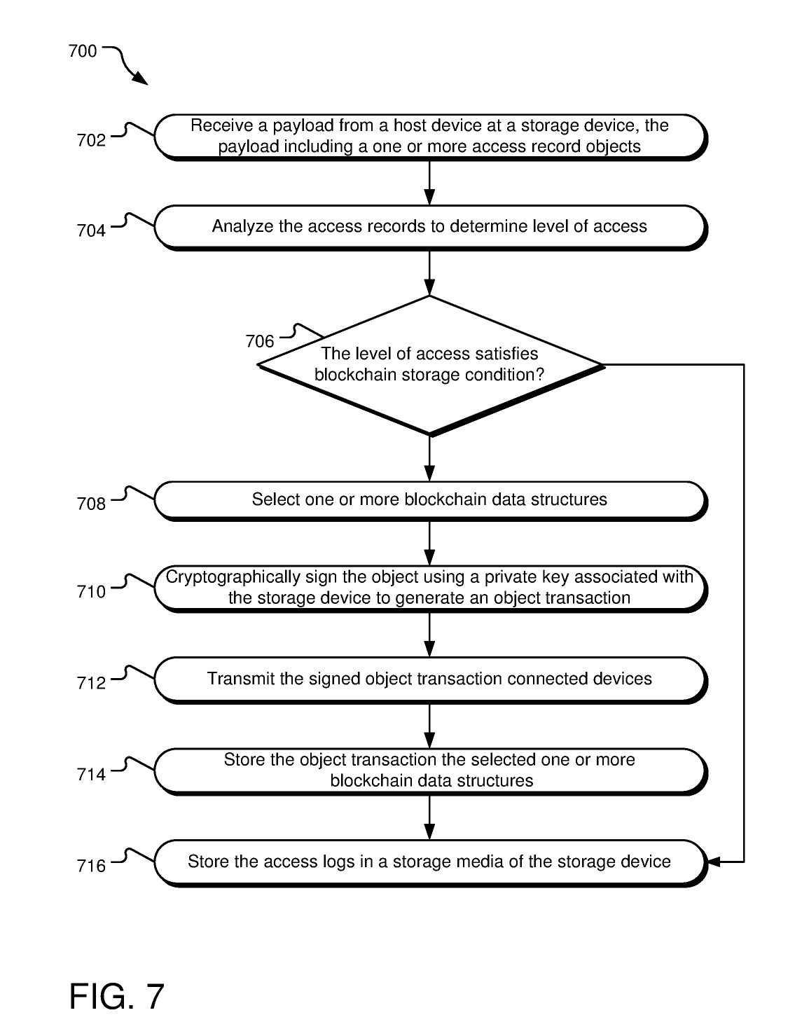

FIG. 7 illustrates alternative example operations 700 for storing an object to a blockchain stored in a blockchain storage device. A receiving operation 702 receives a payload from a host device at a storage device. The pay includes one or more access record objects (e.g., logs). The access record objects may be cryptographically signed by a singing key of the user of the host device. An analyzing operation 704 analyzes the access records (or metadata included in the payload) to determine the level of access. A determining operation 706 determines whether the level of access satisfies a blockchain storage condition. For example, if the level of access changes (e.g., from a previous level of access), then the condition is satisfied. In another example, if the level of access is above a threshold, then the condition is satisfied. If the condition is satisfied, a selecting operation 708 selects one or more blockchain data structures. The selection may be based on the level of access, for example. A signing operation 710 cryptographically signs the access logs using a private key associated with the storage device to generate an object transaction. A transmitting operation 712 transmits the object transaction to connected devices. A storing operation 714 stores the object transaction to the selected one or more blockchain data structures. A storing operation 716 stores the access log objects in a storage media of the storage device. If the blockchain storage condition is not satisfied, a storing operation 716 stores the access logs in the storage media of the storage device.

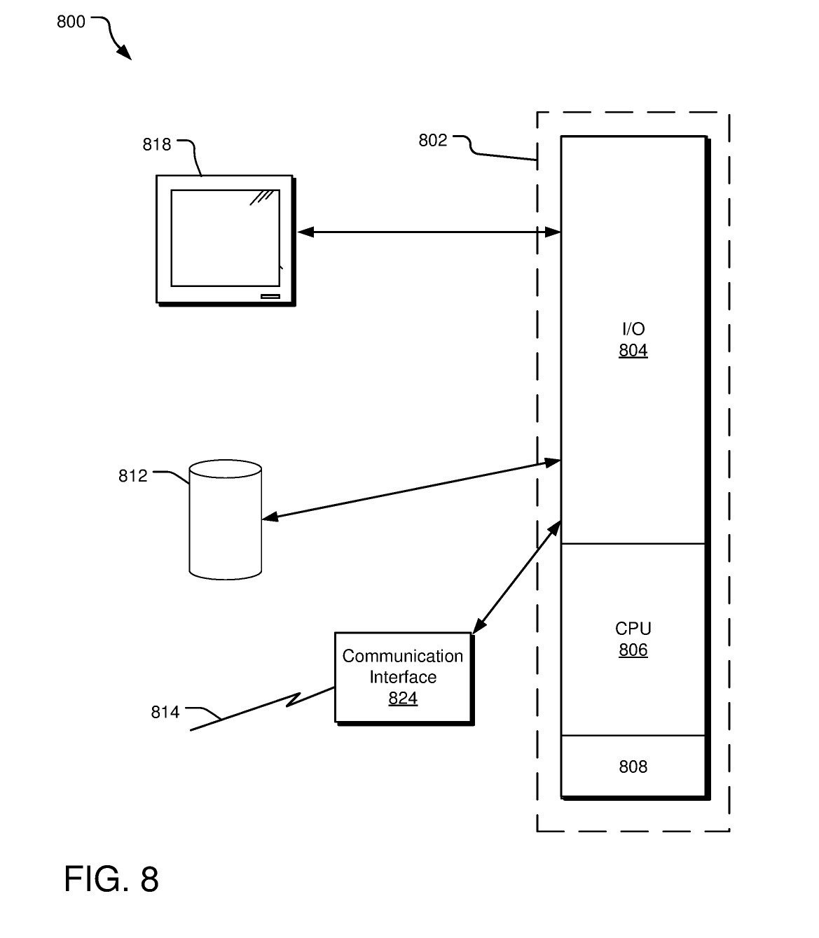

FIG. 8 illustrates an example processing system 800 that may be useful in implementing the described technology. The processing system 800 is capable of executing a computer program product embodied in a tangible computer-readable storage medium to execute a computer process. Data and program files may be input to the processing system 800, which reads the files and executes the programs therein using one or more processors (e.g., CPUs, GPUs, ASICs). Some of the elements of a processing system 800 are shown in FIG. 8 wherein a processor 802 is shown having an input/output (I/O) section 804, a Central Processing Unit (CPU) 806, and a memory section 808. There may be one or more processors 802, such that the processor 802 of the processing system 800 comprises a single central-processing unit 806, or a plurality of processing units. The processors may be single core or multi-core processors. The processing system 800 may be a conventional computer, a distributed computer, or any other type of computer. The described technology is optionally implemented in software loaded in memory 808, a storage unit 812, and/or communicated via a wired or wireless network link 814 on a carrier signal (e.g., Ethernet, 3G wireless, 5G wireless, LTE (Long Term Evolution)) thereby transforming the processing system 800 in FIG. 8 to a special purpose machine for implementing the described operations. The processing system 800 may be an application specific processing system configured for supporting a blockchain storage device.

The I/O section 804 may be connected to one or more user-interface devices (e.g., a keyboard, a touch-screen display unit 818, etc.) or a storage unit 812. Computer program products containing mechanisms to effectuate the systems and methods in accordance with the described technology may reside in the memory section 808 or on the storage unit 812 of such a system 800.

A communication interface 824 is capable of connecting the processing system 800 to an enterprise network via the network link 814, through which the computer system can receive instructions and data embodied in a carrier wave. When used in a local area networking (LAN) environment, the processing system 800 is connected (by wired connection or wirelessly) to a local network through the communication interface 824, which is one type of communications device. When used in a wide-area-networking (WAN) environment, the processing system 800 typically includes a modem, a network adapter, or any other type of communications device for establishing communications over the wide area network. In a networked environment, program modules depicted relative to the processing system 800 or portions thereof, may be stored in a remote memory storage device. It is appreciated that the network connections shown are examples of communications devices for and other means of establishing a communications link between the computers may be used.

In an example implementation, a storage controller, a blockchain decision manager, a cryptography manager, and other modules may be embodied by instructions stored in memory 808 and/or the storage unit 812 and executed by the processor 802. Further, local computing systems, remote data sources and/or services, and other associated logic represent firmware, hardware, and/or software, which may be configured to assist in supporting the blockchain storage device. A blockchain storage may be implemented using a general-purpose computer and specialized software (such as a server executing service software), a special purpose computing system and specialized software (such as a mobile device or network appliance executing service software), or other computing configurations. In addition, keys, device information, identification, configurations, etc. may be stored in the memory 808 and/or the storage unit 812 and executed by the processor 802.

The processing system 800 may be implemented in a device, such as a user device, storage device, IoT device, a desktop, laptop, computing device. The processing system 800 may be a storage device that executes in a user device or external to a user device.

In addition to methods, the embodiments of the technology described herein can be implemented as logical steps in one or more computer systems. The logical operations of the present technology can be implemented (1) as a sequence of processor-implemented steps executing in one or more computer systems and/or (2) as interconnected machine or circuit modules within one or more computer systems. Implementation is a matter of choice, dependent on the performance requirements of the computer system implementing the technology. Accordingly, the logical operations of the technology described herein are referred to variously as operations, steps, objects, or modules. Furthermore, it should be understood that logical operations may be performed in any order, unless explicitly claimed otherwise or unless a specific order is inherently necessitated by the claim language.

Data storage and/or memory may be embodied by various types of processor-readable storage media, such as hard disc media, a storage array containing multiple storage devices, optical media, solid-state drive technology, ROM, RAM, and other technology. The operations may be implemented processor-executable instructions in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

For purposes of this description and meaning of the claims, the term “memory” means a tangible data storage device, including non-volatile memories (such as flash memory and the like) and volatile memories (such as dynamic random-access memory and the like). The computer instructions either permanently or temporarily reside in the memory, along with other information such as data, virtual mappings, operating systems, applications, and the like that are accessed by a computer processor to perform the desired functionality. The term “memory” expressly does not include a transitory medium such as a carrier signal, but the computer instructions can be transferred to the memory wirelessly.

The above specification, examples, and data provide a complete description of the structure and use of example embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A method comprising:
receiving an object at a storage device from a host device, the object being cryptographically signed by the host device, the storage device storing one or more blockchain data structures generated and managed by the storage device;
determining whether the object satisfies a blockchain storage condition, the blockchain storage condition being based at least on a type of the object; and
responsive to determining that the object satisfies the blockchain storage condition, cryptographically signing the object using a cryptographic key associated with the storage device and storing the signed object in the one or more blockchain data structures.

2. The method of claim 1 further comprising:
selecting the one or more blockchain data structures for storing the signed object based on at least on the type of the object.

3. The method of claim 1 wherein the blockchain storage condition is further based on a change in an access log of the storage device.

4. The method of claim 1 wherein the object is a document, the blockchain storage condition being further based on a delta of the document relative to a previous version of the document stored storage device.

5. The method of claim 1 wherein the object is received in a payload that includes an indication of a level of importance of the object, the blockchain storage condition being further based on the level of importance of the object.

6. The method of claim 1 wherein the object is received in a payload that further includes an indication of a level of redundancy of the object, the blockchain storage condition being further based on redundancy of the object.

7. The method of claim 1 wherein the object is received in a payload that includes an identification of a pin, the method further comprising:
transmitting the signed object one or more additional devices for storage in the one or more blockchain data structures.

8. One or more tangible processor-readable storage media encoding processor-executable instructions for executing on a computer system a computer process, the computer process comprising:
receiving an object at a storage device from a host device, the object being cryptographically signed by the host device, the storage device storing one or more blockchain data structures generated and managed by the storage device;
determining whether the object satisfies a blockchain storage condition, the blockchain storage condition being based at least on a type of the object; and
responsive to determining that the object satisfies the blockchain storage condition, cryptographically signing the object using a cryptographic key associated with the storage device and storing the signed object in the one or more blockchain data structures.

9. The one or more tangible processor-readable storage media of claim 8 wherein the process further comprises:
selecting the one or more blockchain data structures for storing the signed object based on at least one of the type of the object.

10. The one or more tangible processor-readable storage media of claim 8 wherein the blockchain storage condition being further based on a change in an access log of the storage device.

11. The one or more tangible processor-readable storage media of claim 8 wherein the object is a document, the blockchain storage condition being further based on a delta of the document relative to a previous version of the document stored in the storage device.

12. The one or more tangible processor-readable storage media of claim 8 wherein object is received in a payload that includes an indication of a level of importance of the object, the blockchain storage condition being further based on the level of importance of the object.

13. The one or more tangible processor-readable storage media of claim 8 wherein the object is cryptographically signed by a private key associated with the host device, the determining operation further comprising:
determining whether the object is validly signed using a public key stored on the storage device.

14. A storage device comprising:
one or more processors;
a memory;
a storage media storing one or more blockchain data structures generated and managed by the storage device;
a blockchain decision manager stored in the memory and executable by the one or more processors to receive an object from a host device, the object being cryptographically singed by the host device, the blockchain decision manager being further executable to determine whether the object satisfies a blockchain storage condition, the blockchain storage condition being based at least on a type of the object; and
a storage controller stored in the memory and executable by the one or more processors to store the object in the one or more blockchain data structures stored in the storage media responsive to determining that the blockchain storage condition is satisfied by the object, the stored object being further cryptographically signed by a cryptographic key associated with the storage device.

15. The storage device of claim 14 wherein the blockchain decision manager is further executable by the one or more processors to select the one or more blockchain data structures for storing the signed object based on at least on the type of the object.

16. The storage device of claim 14 wherein the blockchain storage condition is further based on a change in an access log of the storage device.

17. The storage device of claim 14 wherein the object is a document, the blockchain storage condition being further based on a delta of the document relative to a previous version of the document stored in the storage device.

18. The storage device of claim 14 wherein the object is received in a payload that includes an indication of a level of importance of the object, the blockchain storage condition being further based on the level of importance of the object.

19. The storage device of claim 14 wherein the blockchain decision manager is further executable to receive a read request to read an object associated with the one or more blockchain data structures and to generate a read transaction responsive to determining that the read request is valid, the storage controller being further executable to store the read transaction to the one or more blockchain data structures.

20. The storage device of claim 14 wherein the object cryptographically signed by the cryptographic key associated with the storage device is broadcast to one or more additional storage devices responsive to determining that the object satisfies the blockchain storage condition.
